(19) United States
(12) Patent Application Publication
(10) Pub. No.: US 2002/0067705 A1
(43) Pub. Date: Jun. 6, 2002

(54) Hybrid two-way radio communication system

(76) Inventors: Noah P. Orlen, Boca Raton, FL (US); Michael J. DeLuca, Bocaraton, FL (US)

Correspondence Address: CLARITI TELECOMMUNICATIONS INTERNATIONAL, LTD., INTELLECTUAL PROPERTY DEPARTMENT, ATTN: MICHAEL J. DELUCA, 1920 CORPORATE DRIVE, BOYNTON BEACH, FL, 33426, US

(21) Appl. No.: 09/730,331

(22) Filed: Dec. 5, 2000

(51) Int. Cl. H04L 12/28

(52) U.S. Cl. 370/329; 370/389

(57) ABSTRACT

A hybrid communication system communicates at least a portion of a massage from a message server to a portable device using a wide area communication system such as a one-way communication operating on an FM SCA spectrum. The message may be a digitized voice message. Upon hearing the message, a user of the portable device records an audio response which is stored as a digital reply. When the portable device travels in range of a local area node such as a short range node communicating on the ISM band. Communication is established and a bartering process allows the message to be relayed from the portable device through the local area node relay and back to the message server. The bartering operation requires an act or omission by the portable device and/or its user in exchange for the bandwidth used to relay the response. The act or omission may include exposure to advertising, communication of profile information, response to certain questions or traveling to certain locations, thereby eliminating a monitory exchange process in support of expenses related to the local area node and the bandwidth used.

### FIELD OF THE INVENTION

This invention relates to a two-way radio communication system.

### BACKGROUND OF THE INVENTION

One-way radio communication systems economically communicate from at least one wide area transmitter to a plurality of portable devices. ClariCAST™ is such a system and is produced by Clariti™ Telecommunications International, Ltd. The system communicates digitized voice originating from a telephone voice mail application to a VOCA™ wireless voice player. ClariCAST. The wireless system uses the FM SCA spectrum to wireless communicate digitized voice from a voice mail message server to the VOCA. This system has the advantage of being uniquely adapted to communicate large digital messages over the FM SCA band. The FM SCA spectrum has the unique advantage of providing a low cost communication spectrum. The SCA spectrum is already allocated and there are no governmental spectrum, auctioning or antenna site location expenses. Furthermore, since the FM SCA system is supported by an existing backbone of FM radio station transmitter and antenna towers. The additional cost of establishing a FM SCA communication system is very low. While the ClariCAST system carries digitized voice messaging, other data applications are readily added to the system. Thus, the system has the advantage of providing wide area digital communications to a plurality of portable devices at a very low cost. While SCA enables a one-way communication system which allows messages to be received by the portable device, the portable device cannot send messages via the FM SCA system.

Local area wireless communication systems also provide for low cost communication. Such systems include two-way infrared systems and two-way ISM band systems such as the Bluetooth communication system. Such systems have an advantage in allowing low cost digital communications with a portable device but are very limited in range. For example an infrared local area node requires a portable device to be within several feet and within line of sight in order to communicate. The Bluetooth system has the advantage of omni-directional cells. But such cells have a limited size radius of 30 feet and thus called pico-cells. Such cells are significantly smaller than ClariCAST's FM SCA cells that can have a size radius exceed twenty miles. Thus, such local nodes have the advantage of providing low cost two-way communication but are limited in size and thus limit the portability of a low cost portable device.

Local area nodes can be coupled to the Internet allowing the portable device access to a number of information sources coupled to the Internet. It would be desirable to allow a number of portable devices to interact with the Internet. It is desirable to establish a network of local area nodes, a pico-net, allowig most any portable device to use the node to relay information. However, there is recurring cost in maintaining a connection between a local area node and the Internet in order to relay information between the remote device and the Internet information source.

Thus, what is needed is a two-way hybrid communication system realizing the advantages of a wide-area one-way communication system and a two-way local node communication system where each portable device relaying information through the two-way local node shares in costs associated with the two-way local node.

### BRIEF DESCRIPTION OF THE DRAWINGS

FIG. 1 shows a hybrid two-way communication system in accordance with the present invention.

FIG. 2 shows a block diagram of a portable device operation in accordance with the present invention.

FIG. 3 shows a block diagram of a local area node operation in accordance with the present invention.

FIG. 4 shows a flowchart of a hybrid two-way communication system operating in accordance with the present invention.

### DETAILED DESCRIPTION OF THE INVENTION

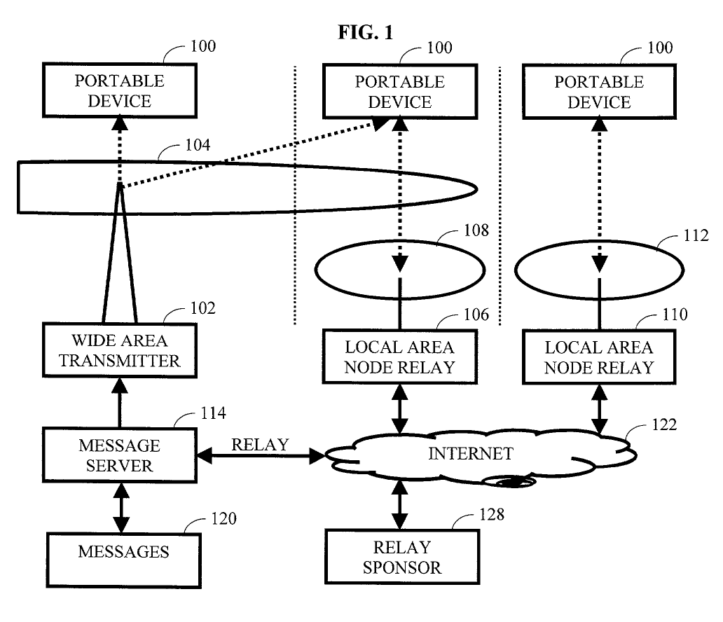

FIG. 1 shows a hybrid two-way communication system in accordance with the present invention. Portable device 100 is able to communicate with wide area transmitter 102 in wide area 104. Wide-area transmitter 102 is preferably an FM radio station transmitting digital information on an SCA subcarrier using the ClariCAST one-way communication protocol. Wide-area transmitter 102 may also comprise a number of FM transmitters networked to form a much larger wide-area 104. Portable device 100 is also able to interface with local area node relays 106, 110 in corresponding areas 108, 112. Area 108 is shown overlapping with area 104 while area 112 does not overlap with area 104. Wide area transmitter 102 is coupled to message server 114 which receives messages from message source 120. Message source 120 may be a voice mail server or a telephone interface providing digitized voice for transmission to portable device 100. Message source 120 may be any other message source such as a computer, Internet information server, or other digital message generator. Local area relay nodes 106 and 110 are coupled to Internet 122 which is also connected to message server 114. When portable device 100 is in area 108, it may interface with the message server either by the one-way wide area transmitter 102 or the two-way local area node relay 106 that relays information between the message server 114 via Internet 122. When portable device 100 is in area 112, it may interface with the message server by the two-way local area node relay 110 that relays information between the message server 114 via Internet 122. The cost of providing access through local area nodes 106 and 110 is at least partially subsidized by a relay sponsor. The relay sponsor has a server 128 coupled to the Internet and interfacing with local area relay nodes 106, 110. Preferably local area node relays use Bluetooth wireless interfaces with portable device 100. In alternate embodiments, alternate wireless interfaces may be used. Furthermore in alternated embodiments networks other than the Internet 112 may be used. Other embodiments may use an alternate one-way communication system such as a POCSAG or FLEX one way wireless paging system. Furthermore, alternate embodiments may realize the wide area communication system with a cellular, PCS or third generation two-way communication system.

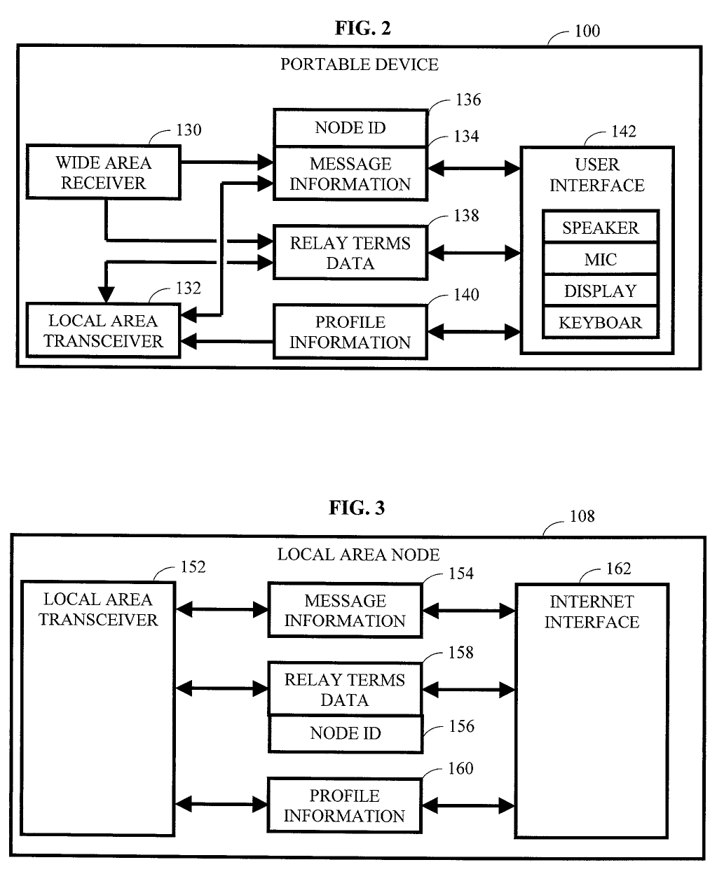

FIG. 2 shows a block diagram of a portable device operation in accordance with the present invention. Portable device includes a wide area receiver. Preferably wide area receiver receives and processes FM SCA spectrum for ClariCAST formatted information. Portable device also includes a local area transceiver 132 for wirelessly interfacing with local area not relays 106, 110. The local area transceiver 132 is preferably a Bluetooth transceiver but could alternately be an of another verity of local area transceivers include infrared or radio frequency transceivers. Information received by wide area receiver 130 is stored in message information memory 134. Message information memory may include a node identification signal 136 selectively identifying at least one of a plurality of local area nodes for relaying information. Relay terms data 138 may also be received by the wide area receiver. Local area transceiver 132 is also capable of communicating message information 134, node identification 136, and relay terms data 138 with a local area node relay. Furthermore, local area transceiver 132 also communicates profile information 140 with the local area node relay. Profile information may include information regarding the portable device or the user or the behavior of either. Portable device profile information may include hardware and software configurations, types of information processed and usage patterns of the portable device. User profile information may include user name, address, age, buying patterns, and financial status. Message information 134, relay terms data 138 and profile information 140 may also be accessed via user interface 142 which may include a speaker for presenting a digitized voice message as an audio message to a user, a microphone for receiving a reply message from the user of the portable device. A display for presenting viewable message information to the user, and a keyboard for receiving a data reply message from the user.

FIG. 3 shows a block diagram of a local area node 108 operation in accordance with the present invention. Local area transceiver 152 wirelessly interfaces with local area transceiver 132 of portable device 100. The local area transceiver interfaces with memory and digital processors managing message information buffer 154 for communication with message server 144, node ID 156, relay terms data 158 and profile information 160 for communication with relay sponsor 128. Local area node uses Internet interface 162 to communicate with the message server 144 and relay sponsor 128. The Internet interface may be one of many such interfaces known to those familiar with the art and may include a personal computer coupled to the Internet via a telephone, bridge or other network interface. In alternate embodiments, the interface between local area node 108 and message server 144 and relay sponsor 128 may be one of may alternate network interfaces known to those familiar with the art.

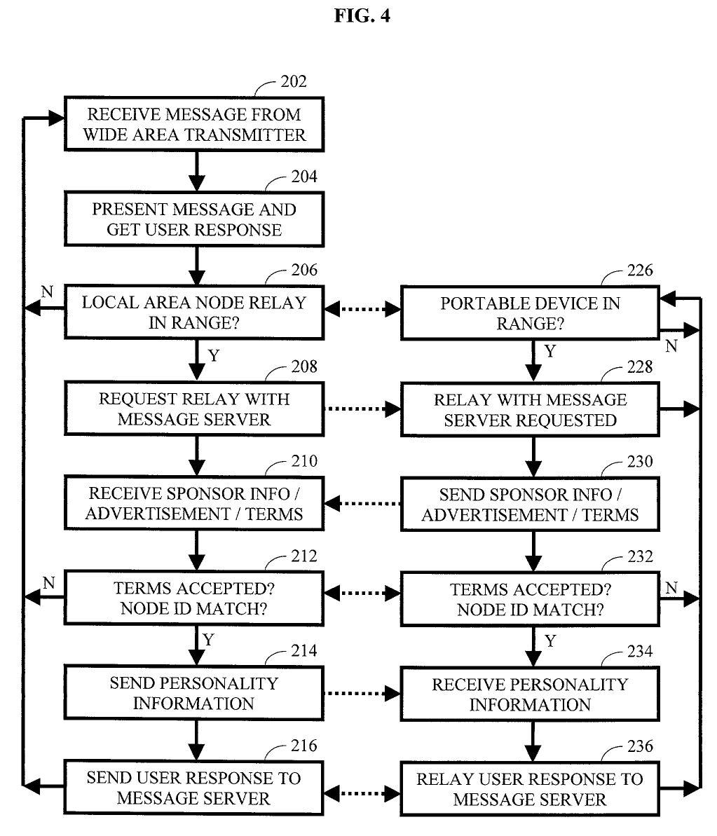

FIG. 4 shows a flowchart of a hybrid two-way communication system operating in accordance with the present invention. Steps 202-216 correspond to operations in the portable device and steps 226-236 corresponds to steps in the local area node. In step 202 at least a portion of a message is sent and received from the wide area transmitter. The message is presented to the user and a response is received from the user at step 204. Then at step 206 determines if the user of the portable device has carried the portable device within range of local area node relay. In step 206, this determination may be made in response to a manual input on the portable device or in response to the local device registering by automatically periodically transmitting a wireless polling signal in order to determine if it is in range. Similarly, step 226 determines if the portable device is in range of the local area node. The determination may be made in response to a manual input or in response to receiving the polling signal. After a link has been established, the portable device requests the node act as a communication relay with the message server at step 208. The request may include a network pointer to the message server such as an Internet URL. The request is received at the node at step 228. The node then may determine if a link with the message server can be established. The node then communicates the terms or policy for completing the relay at step 230. The terms include information from the relay sponsor which may request the user interact with advertisement information on the portable device, or may request transmission of personality information from the portable device, or barter for some other act or omission in exchange for the bandwidth utilized during the information relay. The terms are substantially unrelated to interface information regarding the interface between the portable device and the local area node. The interface information is used to facilitate the successful communication of information between the portable device and the local area node and may include baud rate, frequency, device type and attribute information as may be particular to the local area node and defined by Bluetooth, infrared or other local area node protocol requirements. The terms are received at step 210. The terms may be automatically accepted by the portable device or accepted in response to a manual input from the user at step 212. Step 214 then sends any personality information required as part of the acceptance. Part of the acceptance may optionally require that the local area node have a node ID matching a node ID received in the message from the wide area transmitter. If the acceptance is received by the node at step 232 then the node receives the personality information at step 234. Then relay function between portable device and the message server through the local area node relay is established at step 126 and step 236 allowing two-way communication there between.

The terms for completing the relay may include requiring the user to view an advertisement, or may require the user to complete a survey, or perform some other act or omission to compensate the relay sponsor and/or the provider of the local area node relay for the cost of establishing the relay. In another example, monitoring software or “a cookie” may be loaded from the node into portable device in exchange for the bandwidth. Since cost of the relay is relatively low, typically less than ten cents, and since during the life of a portable device, it may relay through a number of different nodes operated by different node providers, it is not necessarily convenient or efficient to provide monetary compensation for each transaction. Monetary compensation may require undesirable coin slots associated with local area nodes or undesirable credit tracking of a large number of very small amounts. Consequently the relay sponsor barters with the portable device or the user of the portable device to perform an act or omission in exchange for providing the relay bandwidth and system infrastructure for communication with the message server.

Once a relay has been established, any kind of communication is possible between the portable device and the message server. In the preferred embodiment, a reply to a message received over the wide area network is communicated through the relay. However, other types of communication are anticipated. For example, the communication may include message synchronization, software updates, portable device reconfiguration, message service reconfiguration. Alternately, the portable device may interface with any of a number of other information sources coupled to the Internet through the relay. The local area node may monitor the amount of information relayed at step 236 and if excessive may terminate the relay and return to step 230. Thereafter, the barter process of steps 210-214 and 230-234 are repeated before the relay is re-established at steps 216 and 236.

In an application of a use of the hybrid two-way communication system, a user is traveling in an automobile out of range of a local area node and receives a digitized voice message from the wide area transmitter “Mr. Orlen, this is Mr. DeLuca. When and where do you want to meet for lunch?” Upon listening to the message, a reply message is recorded at the portable device, “Mr. DeLuca, this is Mr. Orlen, let's meet at the Ocean Grill at twelve thirty.” When the user enters a retail outlet, the portable device polls and establishes communication with local area node and the terms are communicated to the portable device. The portable device alerts the user and plays an advertisement message, “if you want to send your reply please listen to the following message.” If the user listens to the message “Welcome to our store. If you buy a cup of coffee, then a doughnut is half price”. In response, a relay is established with the message server and reply is relayed. The relay reply is then sent from the message server to Mr. DeLuca preferably using a second portable device and the wide area transmitter. It should be appreciated that the user need not assent to receiving the advertisement message which could be optionally automatically communicated to the portable device as a message from the local area node. In exchange for acceptance of the message the information from the portable device could be relayed in response to the user listening to the advertisement. Alternately, it could be assumed that the user will eventually interact with the advertisement at a later time and the relay provide in exchange for the portable device accepting the advertisement without an sequential act by the user prior to establishing the relay.

In a second application of the hybrid two-way communication system, the user is encouraged to travel to a particular location to access a local area node. This application is useful in marketing models which encourage visitation to specific locations. A message from the message server sent over the wide area transmitter could include a digital representation of the first few seconds of a popular musical score, such as “Smooth” by Santana. Then the message could instruct the user that the rest of the musical score would be available for free or at a reduced price if the user visits a particular local record store. Such a message would select the local node at the record store by providing a node ID uniquely identifying the local area node at the selected record store. Upon hearing the message and a part of the musical score, the user then travels to the indicated record store. Once in the store, the aforementioned process of establishing a relay is performed. It should be noted that the user traveling to the store could be sufficient indication that the user accepts the terms of the relay bandwidth, and additional manual input indicating acceptance is not required. Thereafter, the remainder of the musical score could be loaded into the portable device by the local area node relaying information between the message server and the relay sponsor. It should be further noted that messages 120 could be originated by relay sponsor 128 and that the message server and the relay sponsor may be substantially the same for the transmission of at least the remainder of the musical score. By this method, the hybrid two-way communication system may be used to encourage users to travel to desired locations.

In a third application of the hybrid two-way communication system, the user barters for bandwidth to relay information between an application running on the portable device and the message server, which may have a corresponding application. For example, a user waiting in an airport may be watching a financial program and decide to trade stocks. The user may decide to sell MOT at 18 1/2 and buy CLRI at 3 1/2. The trades are entered in a stock trading application on the portable device. The portable device polls and finds a local area node relay in the airport lobby. In this example the portable device indicates the destination of the relay, www.fidelity.com for example, and that two transactions are to be relayed. Not much bandwidth will be required, so a low value act is requested. The local area node asks the user to respond to a survey message. “Should Vice-president Gore or Governor Bush resign from the presidential post-election contest?” Upon the user acting in response to rendering an opinion, the response is communicated to the local area node and the two transactions relayed between the portable device and the destination server, thereby completing the transactions. The user's response could then be communicated to a survey organization, such as Gallop. It should be appreciated that if more bandwidth were required for the relay, for example stock charts and analysis were to be relayed, then more questions could be posed by the relay sponsor and the local area node relay either before or during the provision of relay bandwidth. Furthermore the user may originate a local area node relay for any reason, one such reason would be a desire to surf the Internet.

In alternate examples of the hybrid two-way communication system, the wide area transmitter could be part of a wide area two-way communication system such as a ReFLEX, cellular, PCS or third generation communication system. The wide area system has the advantage of being able to communicate with the portable device in most areas. While the local area relay node two-way communication system has the advantage in providing for relatively low cost, low power and high data transfer rate communication relative to the wide area two-way communication system.

Thus, what is provided is a two-way hybrid communication system realizing the advantages of a wide-area one-way communication system and a two-way local node communication system where each portable device relaying information through the two-way local node shares in costs associated with the two-way local node without having to establish a monitory exchange.

What is claimed is:

1. A method of facilitating access to a remote server comprising the steps of:
establishing a two-way wireless interface between a portable device and a local area node coupled to the remote server;
communicating terms data to the portable device including terms for establishing an interface between the local area node and the remote server in response thereto;
sending an acceptance signal from the portable device to the local node in response to the terms data; and
relaying information between the portable device and the remote terminal through the local node area in response to the acceptance signal.

2. The method according to claim 1 wherein the terms data requires a user of the portable device to agree to perform an act or omission not related to said step of relaying of information between the portable device and the remote terminal.

3. The method according to claim 1 wherein the terms data requires a user of the portable device to interact with an advertisement presented to the user on the portable device.

4. The method according to claim 1 wherein the portable device includes profile information indicative of the portable device and the terms data requires communication of the profile information from the portable device to the local node.

5. The method according to claim 1 wherein the portable device includes profile information indicative of a user of the portable device and the terms data requires communication of the personality information from the portable device to the local node.

6. The method according to claim 1 wherein the terms data is communicated from the local area node to the portable device.

7. The method according to claim 1 further comprising the step of terminating said step of relaying in response to an amount of information relayed between the portable device and the remote terminal exceeding a predetermined amount.

8. The method according to claim 1 further comprising the steps of:
communicating second terms data to the portable device including terms for continuing the interface between the local node and the remote server in response to an amount of information relayed between the portable device and the remote terminal exceeding a predetermined amount;
sending a second acceptance signal from the portable device to the local area node in response to the second terms data; and
continuing said step of relaying information between the portable device and remote terminal through the local area node in response to the second acceptance signal.

9. The method according to claim 1 wherein the two-way wireless interface is established using a first wireless frequency spectrum and the method further comprises the steps of:
transmitting signals from a wide area node to the portable device, the signals being generated in response to the remote server, and the signals being transmitted on a second wireless frequency spectrum substantially different from the first wireless frequency spectrum, wherein
said step of relaying relays the information through the local area node in response to the signals transmitted by the wide area node.

10. The method according to claim 9 wherein said step of transmitting transmits signals within a first geographical area having a first size and said step of relaying relays the information in a second geographical area having a second size and further wherein the first size is at least ten times greater than the second size.

11. The method according to claim 9 wherein
the wireless interface between the local node and the portable device may not be established if the distance between the portable device and the local node is more than two hundred feet, and
the wireless interface between the wide-area node and the portable device may be established if the distance between the portable device and the local area node is more than two thousand feet.

12. The method according to claim 1 wherein said step of transmitting signals transmits at least a portion of a message from the wide-area node to the portable device and further comprises the steps of:
presenting the message to a user of the portable device; and
receiving a user response signal from the user of the portable device in response to said step of presentation and further wherein
said step of relaying information relays the user response signal from the portable device to the remote terminal through the local area node.

13. The method according to claim 12 wherein the portion of the message includes a digitized signal,
said step of presenting further includes the step of converting the digitized voice signal to a signal perceivable by the user.

14. The method according to claim 12 wherein the portion of the message includes a digitized voice signal,
said step of presenting further includes the step of converting the digitized voice signal to an audio signal, and
said step of receiving receives an audio user response signal from the user and further comprises the steps of:
converting the audio response signal into a second digitized voice signal; and
including the second digitized voice signal with the user response signal.

15. The method according to claim 10 wherein the local area node is a member of a plurality of local area nodes each having a corresponding plurality of non-identical areas and the portable device may be located in any one of the plurality of areas and said steps of sending and relaying may be performed with any member of the plurality of local area nodes when the portable device is located in the corresponding area.

16. The method according to claim 10 wherein the local area node is a member of a plurality of local area nodes each having a corresponding plurality of non-identical areas and the portable device may be located in any one of the plurality of areas wherein
said step of communicating terms data communicates at least a portion of the terms data from wide-area node to the portable device during said step of transmitting signals, the portion of the terms data includes a local identification signal for selectively identifying at least one of the plurality of local area nodes,
said step of sending an acceptance signal includes the step of determining if the local area node has a node identification signal corresponding to the local identification signal and generating an authorization signal in response thereto, and
said step of relaying is enabled only in response to the authorization signal.

17. A relay component of a two-way wireless communication system comprising:
a local area node for wirelessly relaying information between a portable device and an information server through a network; and
a relay sponsor server for establishing relay terms for the relaying of information wherein the relay terms require an act or omission not related to the relaying of information between the portable device and said local area node.

18. The relay component according to claim 18 wherein the relay terms require a user of the portable device to view an advertisement or provide user profile information.

19. The relay component of claim 17 further comprised within a hybrid communication system wherein
said local area node has a first coverage area having a first size and the hybrid communication system further comprises
a wide area transmitter coupled to the information server and for wirelessly transmitting signals to the portable device in a second coverage area having a second size at least ten times greater than the first size, wherein relaying of information between the portable device and the local area node occurs in response to a reception of a signal by the portable device from the wide area transmitter.

20. A method of facilitating access to a remote server comprising the steps of:
transmitting a message signal from a wide area node to a portable device, the message signal being generated by a message server;
generating a reply message at the portable device in response to the message signal;
establishing a two-way wireless interface between the portable device and a local area node coupled to the remote message server in response to the message signal;
communicating an advertisement from the local area node to the portable device, the advertisement being substantially unrelated to interface information regarding the interface between the portable device and the local area node; and
relaying the reply message from the portable device to the message server through the local node area in response to communication of the advertisement.
